(19) United States
(12) Patent Application Publication
(10) Pub. No.: US 2026/0108416 A1
(43) Pub. Date: Apr. 23, 2026

(54) STIMULATION DEVICE

(71) Applicant: Dame Products, Inc., Brooklyn, NY (US)

(72) Inventors: Alexandra Fine, Brooklyn, NY (US); David Block, Brooklyn, NY (US)

(21) Appl. No.: 19/363,989

(22) Filed: Oct. 21, 2025

Related U.S. Application Data
(60) Provisional application No. 63/709,792, filed on Oct. 21, 2024.

(51) Int. Cl. A61H 19/00; A61H 23/02

(52) U.S. Cl. CPC A61H 19/32; A61H 23/02; A61H 2201/163

(57) ABSTRACT

A stimulation device includes a main body housing a vibration motor and one or more arms. Each arm has a proximal end attached to the main body and a distal end opposite the proximal end. The one or more arms are configured to encircle a penis and secure the stimulation device to the penis.

### CROSS-REFERENCE TO RELATED APPLICATION

The present application claims priority to U.S. patent application Ser. No. 63/709,792 filed on Oct. 21, 2024, the entire disclosure of which is incorporated herein by reference.

### TECHNICAL FIELD

The present invention relates to sex toys. More particularly, the present invention pertains sex toys that are configured to secure to a penis and provide stimulation.

### BACKGROUND

A large range of products has been developed and marketed with a recreational purpose, what are commonly referred to as sex toys. These products include a type of penis ring which is designed to fit around the base of the penis. Some of these penis rings are adapted to deliver vibrations to stimulate one or both partners. There remains a need for an improved stimulation device which is configured secure to a penis.

### SUMMARY

The present invention is directed to a device for providing sexual stimulation to a user and/or the user's partner. More specifically, the device is configured to secure to a penis and provide vibrations.

In some exemplary embodiments, a stimulation device made in accordance with the present invention includes a main body housing a vibration motor and one or more arms that extend from the main body. Each arm has a proximal end attached to the main body and a distal end opposite the proximal end. The one or more arms are configured to encircle a penis and secure the stimulation device to the penis.

In some exemplary embodiments, the one or more arms are biased towards a closed arrangement in which the one or more arms collectively define an opening such that, upon applying a force to the one or more arms, the opening collectively defined by the one or more arms enlarges, and, upon releasing the force, the one or more arms return to the closed arrangement

In some exemplary embodiments, a first of the one or more arms curves in a first direction, and a second of the one or more arms curves in a second direction opposite the first direction.

In some exemplary embodiments, the one or more arms include two arms attached to opposite sides of the main body.

In some exemplary embodiments, a clamping member extends from the distal end of a first of the two arms to the distal end of a second of the two arms. In some such embodiments, the clamping member is a spring biased into a circular arrangement. In some particular embodiments, the clamping member includes a bend at each of the distal ends of the two arms.

In some exemplary embodiments, the main body includes an electronics housing containing the vibration motor and the one or more arms includes a clamping member. In some such embodiments, the electronics housing is spaced apart from the clamping member. In some such embodiments, the electronics housing and the clamping member are not rigidly connected. In some particular embodiments, a flexible wall is positioned between the electronics housing and the clamping member.

In some exemplary embodiments, a flexible cover extends across the main body and each of the one or more arms. In some such embodiments, the flexible cover is made of an elastomer, for example, thermoplastic polyurethane or silicone.

In some particular embodiments, the flexible cover defines a cavity in the main body configured to house an electronics housing containing the vibration motor. The flexible cover further defines a channel in each of the one or more arms configured to house a clamping member extending from the proximal end of the one or more arms to the distal end of the one or more arms.

### BRIEF DESCRIPTION OF THE DRAWINGS

FIG. 1 is a perspective view of an exemplary stimulation device made in accordance with the present invention with the two arms in a first arrangement;

FIG. 2 is a side view of the exemplary stimulation device of FIG. 1;

FIG. 3 is a front view of the exemplary stimulation device of FIG. 1;

FIG. 4 is a front view of the exemplary stimulation device with the two arms in a second arrangement;

FIG. 5 is a side view of the exemplary stimulation device of FIG. 1 with the flexible cover removed to show the electronics housing and clamping member in isolation; and

FIG. 6 is a side sectional view of the exemplary stimulation device taken along line 6-6 in FIG. 3.

### DESCRIPTION OF EXEMPLARY EMBODIMENTS

Described herein is a device for providing sexual stimulation to a user and/or the user's partner. More specifically, the device is configured to secure to a penis and provide vibrations.

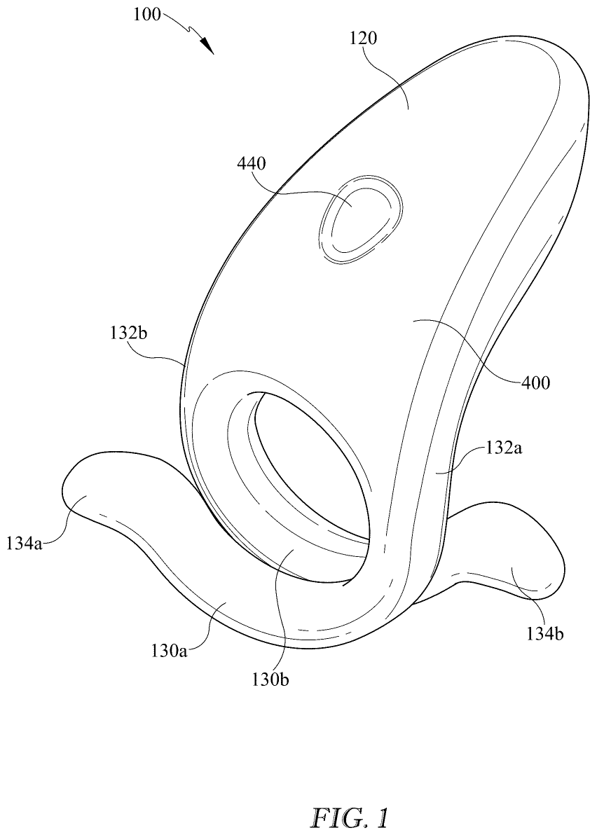

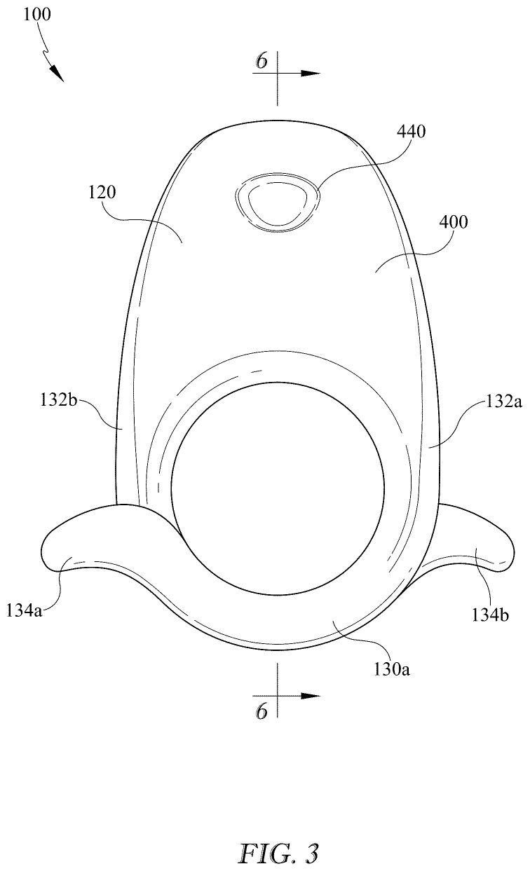

Referring first to FIGS. 1-3, one exemplary stimulation device 100 made in accordance with the present invention includes a main body 120 and two arms 130a, 130b which extend away from the main body 120 with a proximal end 132a, 132b of the two arms 130a, 130b attached to the main body 120 and a distal end 134a, 134b of the two arms 130a, 130b opposite the proximal end 132a, 132b. In the exemplary stimulation device 100, as a first arm 130a extends away from the main body 120, the first arm 130a curves in a first direction (i.e., clockwise in FIG. 3), but as a second arm 130b extends away from the main body 120, the second arm 130b curves in a second direction (i.e., counter-clockwise in FIG. 3) that is opposite the first direction.

As discussed further below, a flexible cover 400 extends across the main body 120 and each of the arms 130a, 130b to provide a substantially continuous and uninterrupted exterior to the device 100. In this way, the flexible cover 400 holds and protects a variety of internal components of the exemplary device 100. The thickness, density, and texture of the flexible cover 400 can be chosen to provide desired tactile sensations as would readily understood by one skilled in the art. In the exemplary device 100, the flexible cover 400 is made of an elastomer, for example, thermoplastic polyurethane or silicone. However, the flexible cover 400 may be made of any material which has properties desirable for the functionality of the stimulation device made in accordance with the present invention. In some embodiments, the flexible cover has one or more of the following properties: easy to clean; hypoallergenic; not heat conducting; elasticity; and malleability. Suitable materials will be well-known to one skilled in the art. The flexible cover may additionally include features to improve the function of the stimulation device 100. For example, the flexible cover may additionally define a plurality of ribs, for example, at the distal ends of the arms.

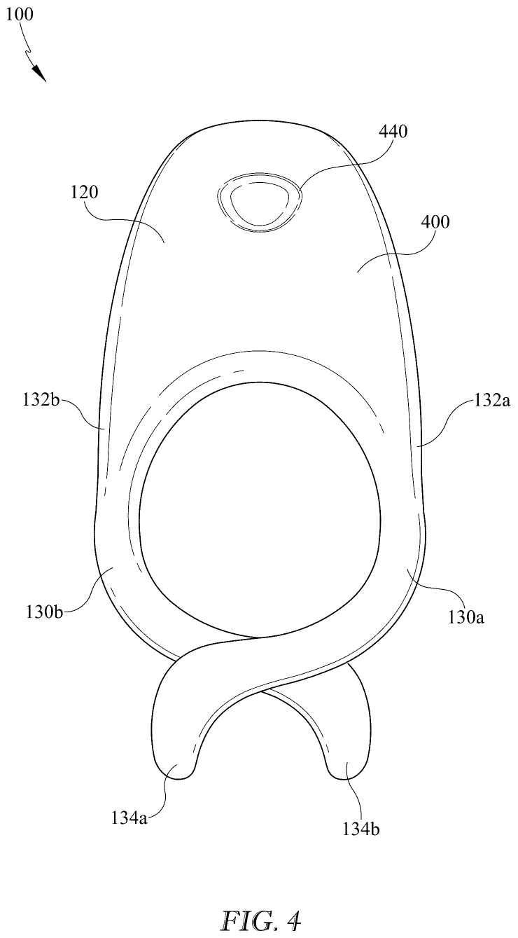

Referring now to FIGS. 3 and 4, the arms 130a, 130b of the exemplary stimulation device 100 are selectively moveable between a first arrangement shown in FIGS. 1-3 and a second arrangement shown in FIG. 4. In the first arrangement (i.e., a closed arrangement), the arms 130a, 130b collectively define an opening configured to encircle a penis and secure the device 100 to the penis. As discussed further below, the arms 130a, 130b are biased towards the first arrangement, but the arms 130a, 130b are flexible so as to allow the arms 130a, 130b to open up for easier placement on and removal from the penis. That is to say, a force can be applied to the arms 130a, 130b to enlarge the opening, for example, as shown in FIG. 4. When the force is removed, the arms 130a, 130b will return to the first arrangement shown in FIG. 3. For example, by pinching the distal ends 134a, 134b of the arms 130a, 130b towards one another, as is illustrated in FIG. 4, the opening defined by the arms 130a, 130b will increase in size. The arms 130a, 130b need only be pulled open to the extent necessary to allow for proper placement and/or removal. As shown in FIG. 3, when the arms 130a, 130b of the exemplary device 100 are in the first arrangement, the opening is substantially circular, but in other embodiments, the shape of the opening defined by the arms 130a, 130b in the first arrangement is not limited so long as the opening is able to effectively secure the device 100 to a penis.

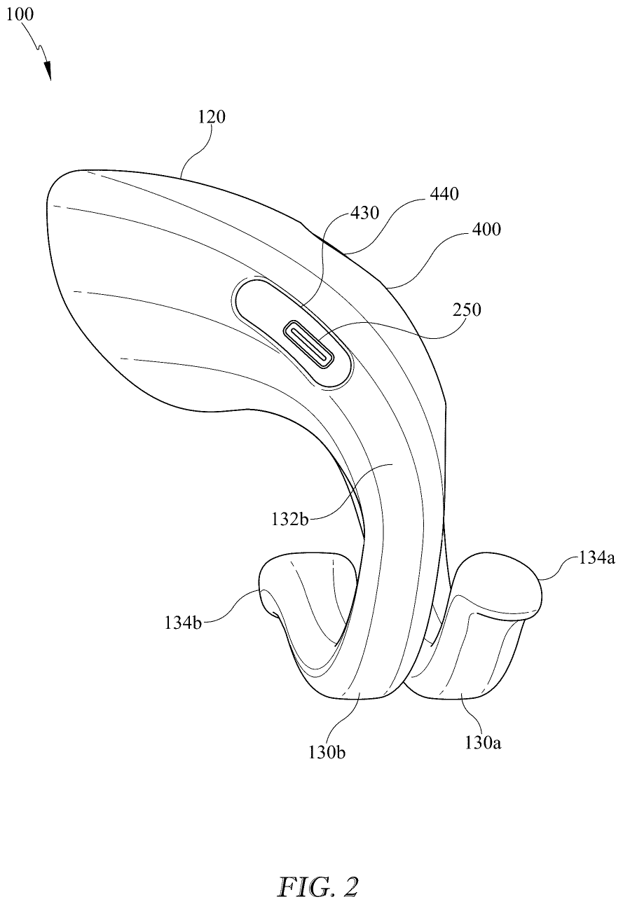

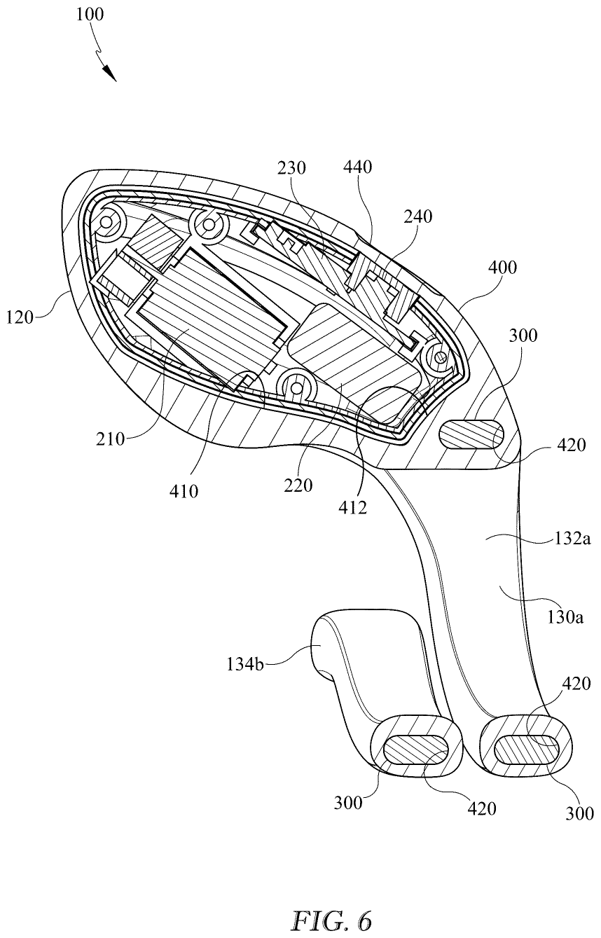

Referring now to FIGS. 2, 5 and 6, the main body 120 of the exemplary stimulation device 100 contains an electronics housing 200. More specifically, and as shown in FIG. 6, the flexible cover 400 defines a cavity 410 in the main body 120 which is configured to house the electronics housing 200. The electronics housing 200 contains a vibration motor 210, a power source 220, and other electronics 230 used to operate and control the vibration motor 210. In the exemplary device 100, the power source 220 is rechargeable, and to this end, as shown in FIG. 2, an access hole 430 is defined through the flexible cover 400 to provide access to a charging port 250. In the exemplary device 100, the charging port 250 is a waterproof USB-C but other charging ports are possible without departing from the spirit and scope of the present invention.

As shown in FIG. 6, a button 240 is also provided within the main body 120 and extending through the electronics housing 200. The button 240 is used not only to turn on and off the device, but, at least in some embodiments, can additional be used to cycle through multiple settings of the device 100 as would be readily understood by one skilled in the art. As shown in FIGS. 1-4 and 6, the portion of the flexible cover 400 positioned above the button 240 includes an indentation on the outer surface which operates at an indicator 440. Upon applying a force to the indicator 440, the flexible cover 400 will flex and allow the button 240 to be depressed, thereby turning on and off the vibration motor 210 and/or controlling different modes of operation.

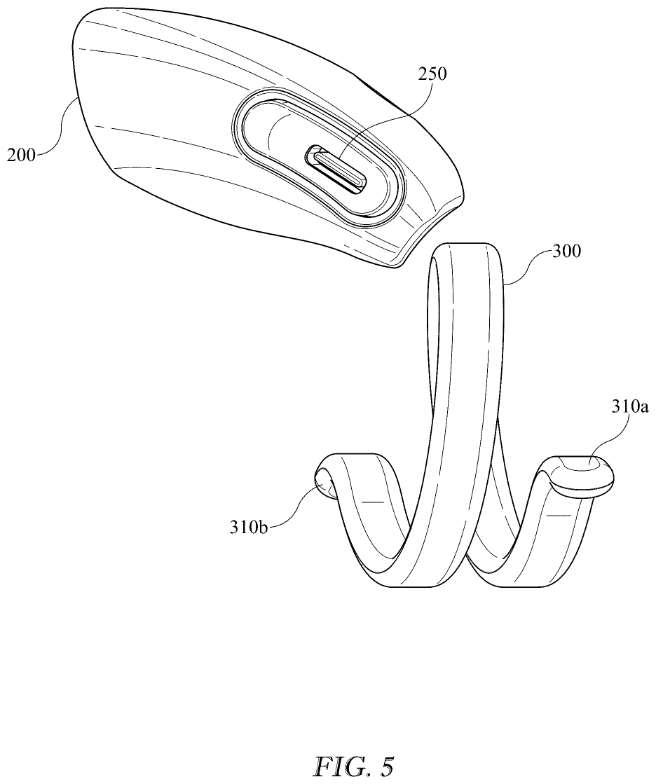

As previously mentioned, the arms 130a, 130b are flexible and biased towards the first arrangement shown in FIGS. 1-3. In the exemplary device 100, and referring now to FIGS. 5 and 6, a clamping member 300 extends from the distal end 134a of the first arm 130a to the distal end 134b of the second arm 130b within the flexible cover 400. In particular, the flexible cover 400 defines a channel 420 that extends through the arms 130a, 130b and which is configured to house the clamping member 300. As perhaps best shown in FIG. 5, the exemplary clamping member 300 is a unitary piece of resilient material that operates as a spring biased into a circular arrangement which corresponds to the first arrangement of the arms 130a, 130b. The exemplary clamping member 300 additionally includes a bend at each of its distal ends 310a, 310b to facilitate a user in pinching the distal ends 134a, 134b of the arms 130a, 130b towards one another to increase the size of the opening defined by the arms 130a, 130b. The particular material and configuration of the clamping member 300 is not limited and may vary without departing from the spirit and scope of the present invention.

For example, other shapes of the clamping member are possible so long as the clamping member is configured to effectively secure the device to a penis. Furthermore, in some embodiments, each arm has its own separate clamping member that extends along substantially the entire length of the arms. In some such embodiments, the clamping members of the multiple legs are springs biased to collectively define a circular arrangement, similar to what is shown in FIG. 3. Further still, in some embodiments, rather than being a spring biased into a circular arrangement, the clamping member may be a flexible member which retains its shape when bent. Additionally, regardless of the particular form of the clamping member, in some exemplary embodiments, beyond merely securing the device to a penis, the clamping member is configured to also reduce blood circulation in the penis.

In the exemplary stimulation device 100, the two arms 130 extend away from the main body 120 in opposite directions. However other configurations are possible without departing from the spirit and scope of the present invention. For example, in some embodiments, a single arm may be provided with the single arm configured to sufficiently secure the device to a penis. Likewise, three or more arms may be provided without departing from the spirit and scope of the present invention. Furthermore, the particular location in which the arms are attached to the main body is not limited.

Referring now once again to FIGS. 5 and 6, in the exemplary stimulation device 100, the electronics housing 200 is spaced apart from the clamping member 300. As shown in FIG. 6, the flexible cover 400 includes a wall 412 separating the electronics housing 200 from the clamping member 300. However, in some other embodiments, the cavity of the flexible cover containing the electronics housing is in communication with the channel containing the clamping member. In other words, there is an air gap defined between the electronics housing and the clamping member. In either event, it is contemplated that the electronics housing and the clamping members do not touch one another and have no rigid connection whatsoever. It is contemplated that the lack of rigid connection allows for flexure between the electronics housing and the clamping members.

One of ordinary skill in the art will recognize that additional embodiments are also possible without departing from the teachings of the present invention or the scope of the claims which follow. This detailed description, and particularly the specific details of the exemplary embodiment disclosed herein, is given primarily for clarity of understanding, and no unnecessary limitations are to be understood therefrom, for modifications will become apparent to those skilled in the art upon reading this disclosure and may be made without departing from the spirit or scope of the claimed invention.

What is claimed is:

1. A stimulation device configured to secure to a penis, comprising:
a main body housing a vibration motor; and
one or more arms each having a proximal end attached to the main body and a distal end opposite the proximal end, the one or more arms configured to encircle a penis and secure the stimulation device to the penis.

2. The stimulation device of claim 1, wherein the one or more arms are biased towards a closed arrangement in which the one or more arms collectively define an opening such that, upon applying a force to the one or more arms, the opening collectively defined by the one or more arms enlarges, and, upon releasing the force, the one or more arms return to the closed arrangement.

3. The stimulation device of claim 1, wherein a first of the one or more arms curves in a first direction, and a second of the one or more arms curves in a second direction opposite the first direction.

4. The stimulation device of claim 1, wherein the one or more arms include two arms attached to opposite sides of the main body.

5. The stimulation device of claim 4, wherein a clamping member extends from the distal end of a first of the two arms to the distal end of a second of the two arms.

6. The stimulation device of claim 5, wherein the clamping member is a spring biased into a circular arrangement.

7. The stimulation device of claim 5, wherein the clamping member includes a bend at each of the distal ends of the two arms.

8. The stimulation device of claim 1, wherein the main body includes an electronics housing containing the vibration motor;
wherein the one or more arms includes a clamping member; and
wherein the electronics housing is spaced apart from the clamping member.

9. The stimulation device of claim 8, wherein the electronics housing and the clamping member are not rigidly connected.

10. The stimulation device of claim 8, wherein a flexible wall is positioned between the electronics housing and the clamping member.

11. The stimulation device of claim 8, wherein the clamping member is a spring biased into a circular arrangement.

12. The stimulation device of claim 1, further comprising a flexible cover extending across the main body and each of the one or more arms.

13. The stimulation device of claim 12, wherein the flexible cover is made of an elastomer.

14. The stimulation device of claim 12, wherein the flexible cover defines a cavity in the main body configured to house an electronics housing containing the vibration motor, and a channel in each of the one or more arms, each channel configured to house a clamping member extending from the proximal end of the one or more arms to the distal end of the one or more arms.

15. The stimulation device of claim 14, wherein the electronics housing is spaced apart from the clamping member.

16. The stimulation device of claim 14, wherein the flexible cover includes a wall separating the cavity in the main body from the channel in each of the one or more arms.

17. A stimulation device configured to secure to a penis, comprising:
a main body;
one or more arms each having a proximal end attached to the main body and a distal end opposite the proximal end, the one or more arms configured to encircle a penis and secure the stimulation device to the penis;
a flexible cover extending across the main body and each of the one or more arms, the flexible cover defining a cavity in the main body and a channel in each of the one or more arms;
an electronics housing positioned in the cavity of the flexible cover;
a vibration motor positioned within the electronics housing; and
a clamping member positioned in the channel and extending from the proximal end of the one or more arms to the distal end of the one or more arms.

18. The stimulation device of claim 17, wherein the electronics housing further includes a rechargeable power source to provide power to the vibration motor and a charging port extending through the flexible cover.

19. The stimulation device of claim 18, wherein the charging port is a waterproofed USB-C.

20. A stimulation device configured to secure to a penis, comprising:
a main body housing a vibration motor; and
a first arm extending from the main body and biased towards a closed arrangement in which the first arm curves in a first direction;
a second arm extending from the main body and biased towards a closed arrangement in which the second arm curves in a second direction opposite the first direction;
wherein when the first arm and the second arm are in the closed arrangement, the first arm and the second arm collectively define an opening configured to encircle a penis and secure the stimulation device to the penis.
